(19) United States
(12) Patent Application Publication
(10) Pub. No.: US 2026/0024803 A1
(43) Pub. Date: Jan. 22, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Dasol JUN, Yongin-si (KR); HYUNBONG CHOI, Yongin-si (KR); Sangwoo PARK, Yongin-si (KR); Woojung JI, Yongin-si (KR); Sohee KIM, Yongin-si (KR); Hongryeol PARK, Yongin-si (KR); Yeji YANG, Yongin-si (KR); Youngkyeong SHIN, Yongin-si (KR); SANGHOON KIM, Yongin-si (KR)

(21) Appl. No.: 19/062,813

(22) Filed: Feb. 25, 2025

(30) Foreign Application Priority Data
Jul. 22, 2024 (KR) 10-2024-0096431

(51) Int. Cl. H01M 10/0525; H01M 4/02; H01M 4/36; H01M 4/38; H01M 4/525; H01M 4/583; H01M 10/0567; H01M 10/0568; H01M 10/0569

(52) U.S. Cl. CPC H01M 10/0525; H01M 4/366; H01M 4/386; H01M 4/525; H01M 4/583; H01M 10/0567; H01M 10/0568; H01M 10/0569; H01M 2004/027; H01M 2004/028; H01M 2300/004

(57) ABSTRACT

Disclosed are electrolytes and rechargeable lithium batteries. The electrolyte includes a non-aqueous organic solvent, a phosphorus-based lithium salt, an imide-based lithium salt, and an additive. The additive includes an aliphatic disocyanate compound.

### CROSS-REFERENCE TO RELATED APPLICATION

The present application claims priority to and the benefit of Korean Patent Application No. 10-2024-0096431, filed on Jul. 22, 2024, in the Korean Intellectual Property Office, the entire content of which is hereby incorporated by reference.

### BACKGROUND

Embodiments of the present disclosure relate to an electrolyte for a rechargeable lithium battery and a rechargeable lithium battery including the same.

Recently, with the rapid spread of battery using electronic devices, such as mobile phones, laptop computers, and electric vehicles, there is a rapidly increasing demand for or interest in rechargeable batteries having high energy density and high capacity. Therefore, intensive research has been conducted to improve performance of rechargeable lithium batteries.

A rechargeable lithium battery includes a positive electrode, a negative electrode, and an electrolyte, which positive and negative electrodes include an active material in which intercalation and deintercalation are possible, and generates electrical energy caused by oxidation and reduction reactions if (e.g., when) lithium ions are intercalated and deintercalated.

### SUMMARY

An embodiment of the present disclosure provides an electrolyte for a rechargeable lithium battery having increased cycle-life characteristics, excellent high-temperature characteristics, and superior stability.

An embodiment of the present disclosure provides a rechargeable lithium battery including the electrolyte.

According to an embodiment of the present disclosure, an electrolyte for a rechargeable lithium battery may include: a non-aqueous organic solvent; a phosphorus-based lithium salt; an imide-based lithium salt; and an additive. The additive may include an aliphatic diisocyanate compound.

According to an embodiment of the present disclosure, a rechargeable lithium battery may include: a positive electrode that includes a positive electrode active material; a negative electrode that includes a negative electrode active material; and the aforementioned electrolyte for the rechargeable lithium battery.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a simplified conceptual diagram showing a rechargeable lithium battery according to an embodiment of the present disclosure.

FIGS. 2-5 are simplified diagrams showing rechargeable lithium batteries

according to embodiments of the present disclosure.

### DETAILED DESCRIPTION

In order to sufficiently understand the configuration and effect of the subject matter of the present disclosure, some embodiments of the present disclosure will be described with reference to the accompanying drawings. It should be noted, however, that the present disclosure is not limited to the following example embodiments, and may be implemented in various suitable forms. Rather, the example embodiments are provided only to disclose the subject matter of the present disclosure and let those having ordinary skill in the art fully know the scope of the present disclosure.

In this description, it will be understood that, if (e.g., when) an element is referred to as being on another element, the element can be directly on the other element or intervening elements may be present between therebetween. In the drawings, thicknesses of some components may be exaggerated to effectively explain the technical contents of the present disclosure. Like reference numerals refer to like elements throughout the specification.

Unless otherwise specially noted in this description, the expression of singular form may include the expression of plural form. In addition, unless otherwise specially noted, the phrase “A or B” may indicate “A but not B”, “B but not A”, and “A and B”. The terms “comprises/includes” and/or “comprising/including” used in this disclosure do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In embodiments, a particle diameter indicates an average particle diameter (D₅₀) where a cumulative volume is about 50 volume % in a particle size distribution. The average particle diameter (D₅₀) may be measured by any suitable method generally used in the art, for example, by a particle size analyzer, a transmission electron microscope (TEM) image, and/or a scanning electron microscope (SEM) image. In embodiments, a dynamic light-scattering measurement device may be used to perform a data analysis, the number of particles is counted for each particle size range, and then from this, an average particle diameter (D₅₀) value may be obtained through a calculation. In embodiments, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, or a combination thereof.

In more detail, the term “substituted” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. In embodiments, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

Unless otherwise defined, all chemical names, technical and scientific terms, and terms defined in common dictionaries should be interpreted as having meanings consistent with the context of the related art, and should not be interpreted in an ideal or overly formal sense. It will be understood that, although the terms first, second, and/or the like may be used herein to describe certain elements, these elements should not be limited by these terms. These terms are only used to distinguish one element from another element. Thus, a first element could be termed a second element without departing from the teachings of the present disclosure. Similarly, a second element could be termed a first element.

As used herein, expressions such as “at least one of,” “one of,” “at least one selected from among,” and “selected from among,” if (e.g., when) preceding a list of elements, modify the entire list of elements and do not modify the individual elements of the list. As utilized herein, the expressions “at least one of A, B, or C”, “one of A, B, C, or a combination thereof” and “one of A, B, C, and a combination thereof” refer to each component and a combination thereof (e.g., A; B; A and B; A and C; B and C; or A, B, and C). For example, “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the terms “use,” “using,” and “used” may be considered synonymous with the terms “utilize,” “utilizing,” and “utilized,” respectively.

The term “may” will be understood to refer to “one or more embodiments of the present disclosure,” some of which include the described element and some of which exclude that element and/or include an alternate element. Similarly, alternative language such as “or” refers to “one or more” or “some” “embodiments of the present disclosure,” each including a corresponding listed item.

In this context, “consisting essentially of” means that any additional components will not materially affect the chemical, physical, optical or electrical properties of the semiconductor film.

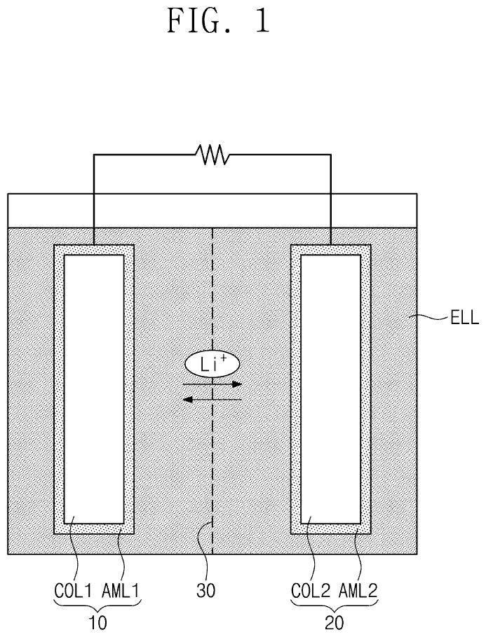

FIG. 1 is a simplified conceptual diagram showing a rechargeable lithium battery according to an embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated with the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and further include a binder and/or a conductive material (e.g., an electrically conductive material).

For example, the positive electrode 10 may further include an additive that can serve as a sacrificial positive electrode.

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth) acrylated styrene-butadiene rubber, epoxy resin, (meth) acrylic resin, polyester resin, and/or nylon, but the present disclosure is not limited thereto.

The conductive material may be used to provide an electrode with conductivity (e.g., electrical conductivity), and any suitable conductive material that does not cause a chemical change in a battery (e.g., substantially does not cause an undesirable chemical change in the rechargeable lithium battery) may be used as the conductive material. The conductive material may include, for example, a carbon-based material such as natural graphite, artificial graphite, carbon black, acetylene black, Ketjen black, carbon fiber, carbon nano-fiber, and/or carbon nano-tube; a metal powder and/or metal fiber containing one or more of copper, nickel, aluminum, and/or silver; a conductive polymer (e.g., an electrically conductive polymer) such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from cobalt, manganese, nickel, and a combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one selected from among chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li(_{3-f})Fe₂(PO₄)₃ (where 0≤f≤2); and LiₐFePO₄ (where 0.90≤a≤1.8).

In the chemical formulae above, A is Ni, Co, Mn, or a combination thereof, X is Al, Ni, Co, Mn, Cr, Fe, Mg, Sr, V, a rare-earth element, or a combination thereof, D is O, F, S, P, or a combination thereof, G is Al, Cr, Mn, Fe, Mg, La, Ce, Sr, V, or a combination thereof, and L¹ is Mn, Al, or a combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material and may further include a binder and/or a conductive material (or an electrically conductive material).

For example, the negative electrode active material layer AML2 may include a negative electrode active material of about 90 wt % to about 99 wt %, a binder of about 0.5 wt % to about 5 wt %, and a conductive material (e.g., an electrically conductive material) of about 0 wt % to about 5 wt %.

The binder may serve to improve or enhance attachment of negative electrode active material particles to each other and also to improve or enhance attachment of the negative electrode active material to the current collector COL2. The binder may include a non-aqueous binder, an aqueous binder, a dry binder, or a combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

If (e.g., when) an aqueous binder is used as the negative electrode binder, a cellulose-based compound capable of providing or increasing viscosity may further be included. The cellulose-based compound may include one or more selected from among carboxymethyl cellulose, hydroxypropylmethyl cellulose, methyl cellulose, and alkali metal salts thereof. The alkali metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, or a combination thereof.

The conductive material may be used to provide an electrode with conductivity (e.g., electrical conductivity), and any suitable conductive material that does not cause a chemical change in a battery (e.g., substantially does not cause an undesirable chemical change in the rechargeable lithium battery) may be used as the conductive material. For example, the conductive material may include a carbon-based material such as natural graphite, artificial graphite, carbon black, acetylene black, Ketjen black, carbon fiber, carbon nano-fiber, and/or carbon nano-tube; a metal powder and/or metal fiber including one or more selected from among copper, nickel, aluminum, and silver; a conductive polymer (e.g., an electrically conductive polymer) such as a polyphenylene derivative; or a mixture thereof.

The current collector COL2 may include a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, and/or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, and/or fiber-shaped natural and/or artificial graphite, and the amorphous carbon may include soft carbon, hard carbon, mesophase pitch carbon, and/or calcined coke.

The lithium metal alloy may include an alloy of lithium and metal that is selected from Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material and/or a Sn-based negative electrode active material. The Si-based negative electrode active material may include silicon, silicon-carbon composite, SiOx (where 0<x<2), Si-Q alloy (where Q is alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) on a surface of the secondary particle. The amorphous carbon may also be between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer on a surface of the core.

The Si-based negative electrode active material and/or the Sn-based negative electrode active material may be used in combination with a carbon-based negative electrode active material.

### Separator 30

Based on a type (or kind) of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer on one or opposite surfaces (e.g., two opposing surfaces) of the porous substrate, which coating layer includes an organic material, an inorganic material, or a combination thereof.

The porous substrate may be a polymer layer including one selected from polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be a copolymer or mixture including two or more of the materials mentioned above.

The organic material may include a polyvinylidenefluoride-based copolymer and/or a (meth) acrylic copolymer.

The inorganic material may include an inorganic particle selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for that transmits ions that participate in an electrochemical reaction of the battery.

The non-aqueous organic solvent may include a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, and/or caprolactone.

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The alcohol-based solvent may include ethyl alcohol and/or isopropyl alcohol. The aprotic solvent may include nitriles such as R-CN (where R is a hydrocarbon group having a C2 to C20 linear, branched, or cyclic structure and may include a double bond, an aromatic ring, and/or an ether group); amides such as dimethylformamide; dioxolanes such as 1,3-dioxolane and/or 1,4-dioxolane; and/or sulfolanes.

The non-aqueous organic solvent may be used alone or in a mixture of two or more substances.

In embodiments, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9. For example, the cyclic carbonate may include ethylene carbonate (EC), and the chain carbonate may include a combination of dimethyl carbonate (DMC) and ethylmethyl carbonate (EMC).

The non-aqueous organic solvent according to an embodiment of the present disclosure may be formed of only a carbonate-based solvent. In embodiments, the non-aqueous organic solvent may maintain stable characteristics even at high temperatures, and may have superior compatibility with a phosphorus-based lithium salt and an imide-based lithium salt, which will be further discussed below, to improve or enhance ion conductivity of an electrolyte. The non-aqueous organic solvent may include, for example, ethylene carbonate (EC), dimethyl carbonate (DMC), diethyl carbonate (DEC), dipropyl carbonate (DPC), methylpropyl carbonate (MPC), ethylpropyl carbonate (EPC), ethylmethyl carbonate (EMC), or a combination thereof. For example, the non-aqueous organic solvent may include ethylene carbonate (EC), dimethyl carbonate (DMC), and/or ethylmethyl carbonate (EMC).

The lithium salt may be a material that is dissolved in the non-aqueous organic solvent to serve as a supply source of lithium ions in batteries and plays a role in enabling a basic operation of rechargeable lithium batteries and promoting the movement of lithium ions between positive and negative electrodes.

The lithium salt according to the present disclosure may include a phosphorus-based lithium salt and an imide-based lithium salt.

The phosphorus-based lithium salt may include lithium hexafluorophosphate (LiPF₆), lithium difluorophosphate (LiPO₂F₂), lithium tetrafluorophosphate oxalate (LiPF₄(C₂O₄), lithium pentafluorophosphate oxalate (LiPF₅(O₂C₂)), lithium pentafluorophosphate isocyanate (LiPF₅(OCN)), or a combination thereof. In embodiments, it may be beneficial or advantageous for the film formation of LiₓP_{y}O_{z} (where 1≤x≤4, 1≤y≤4, and 0≤z≤7) which is beneficial for cycle-life and high-temperature characteristics, and precipitation of Ni may be prevented.

The imide-based lithium salt may be a bis (sulfonyl)imide-based lithium salt.

The imide-based lithium salt may include, for example, Li(FSO₂)₂N (lithium bis(fluorosulfonyl)imide, LiFSI), LiN(CₓF₂ₓ₊₁SO₂)(C_{y}F_{2y+1}SO₂) (where x and y are each independently an integer of 1 to 20), or a combination thereof. For example, x and y in the LiN(CₓF₂ₓ₊₁SO₂) (C_{y}F_{2y+1}SO₂) may each independently be an integer of 1 to 10 or an integer of 1 to 4.

The phosphorus-based lithium salt and the imide-based lithium salt may be included in a molar ratio of about 1:0.1 to about 1:5. For example, the phosphorus-based lithium salt and the imide-based lithium salt may be included in a molar ratio of about 1:0.2 to about 1:5 or in a molar ratio of 1:0.25 to about 1:1.

If (e.g., when) the phosphorus-based lithium salt and the imide-based lithium salt are included in a molar ratio within the ranges above, it may be possible to prevent or reduce corrosion of a positive electrode current collector and also to improve or enhance cycle-life reduction and gas generation at high-voltage conditions.

An amount of the phosphorus-based lithium salt may range from about 0.3 M to about 1.5 M. For example, the phosphorus-based lithium salt may be present in a concentration of about 0.3 M to about 1.5 M in an electrolyte. If (e.g., when) the phosphorus-based lithium salt is present in an amount within the ranges above, excellent output characteristics may be exhibited by the rechargeable lithium battery.

An amount of the imide-based lithium salt may range from about 0.2 M to about 1.0 M. For example, the imide-based lithium salt may be present in a concentration of about 0.2 M to about 1.0 M in an electrolyte. If (e.g., when) the imide- based lithium salt is present in an amount within the ranges above, it may be suitable because of high ion conductivity compared to an electrolyte where only the phosphorus-based lithium salt is used alone, and it may be possible to delay a cell performance degradation due to decomposition products such as PF₅ and HF generated from decomposition of LiPF₆.

An additive may be a material that is included in an electrolyte and serves functions such as electrode protection, overcharge prevention, improvement in ion conductivity, advancement in high-temperature performance, enhancement in cycle-life characteristics, and/or increase in stability, thereby improving performance of rechargeable lithium batteries.

The additive according to an embodiment may include an aliphatic diisocyanate compound.

Some salt products formed from lithium salt may react with moisture to produce byproducts, and the byproducts may cause a swelling phenomenon or various suitable side reactions. The aliphatic diisocyanate compound may react with moisture to produce amine, and the amine may react with residual aliphatic diisocyanate to produce polyurea, thereby effectively suppressing or reducing an amount of moisture in cells. Therefore, if (e.g., when) the aliphatic diisocyanate compound and the aforementioned lithium salt are utilized in combination, there may be an improvement in cycle-life characteristics under the condition of high voltage and high temperature.

According to an embodiment, the aliphatic diisocyanate compound may include a C3 to C20 alicyclic diisocyanate compound.

The alicyclic diisocyanate compound may have a cyclic structure and excellent chemical resistance to stably form films on surfaces of positive and negative electrodes.

According to an embodiment, the aliphatic diisocyanate compound may include 1,6-hexamethylene diisocyanate (HDI), 4,4′-diisocyanate dicyclohexylmethane (H12MDI), 5-isocyanate-1-isocyanatomethyl-1,3,3-trimethylcyclohexane (isophorone diisocyanate, IPDI), or a combination thereof.

According to an embodiment, the additive may be included in an amount of about 0.01 to 5 parts by weight, for example, about 0.1 to 3 parts by weight or about 0.1 to 1 part by weight relative to the total 100 parts by weight of an electrolyte for a rechargeable lithium battery. If (e.g., when) the additive is included in an amount within the ranges above, a rechargeable lithium battery may be achieved with an improvement in high-temperature storage characteristics and cycle-life properties.

The additive may further include one or more substances other than the compound mentioned above.

The other additive may include at least one selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

The additional inclusion of the aforementioned other additive may further increase a cycle-life or effectively control or reduce a gas generation from the positive and negative electrodes during high-temperature storage.

The additive may be included in an amount of about 0.02 to 10 parts by weight, for example, about 0.2 to 10 parts by weight or about 0.2 to 5 parts by weight relative to the total 100 parts by weight of an electrolyte for a rechargeable lithium battery.

If (e.g., when) the other additive is included in an amount within the ranges above, an increase in film resistance may be minimized or reduced to contribute to an improvement in battery performance.

### Rechargeable Lithium Battery

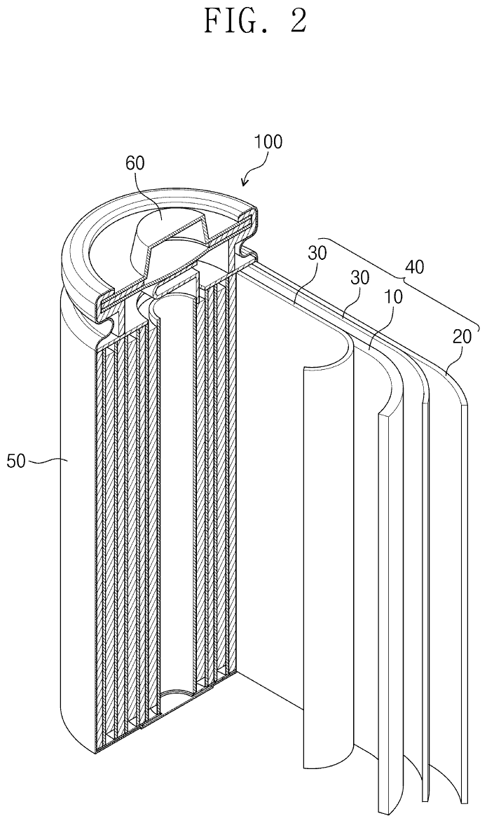

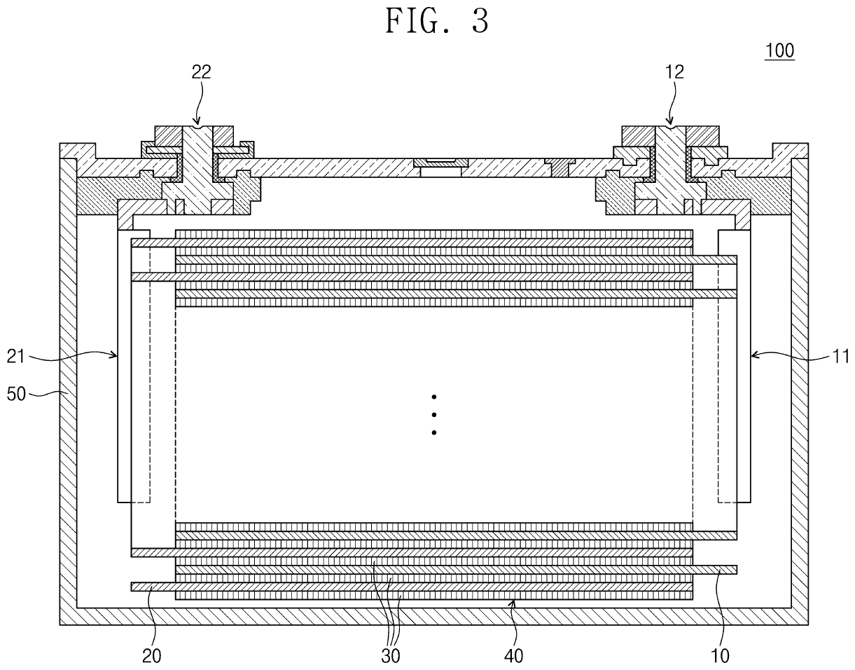

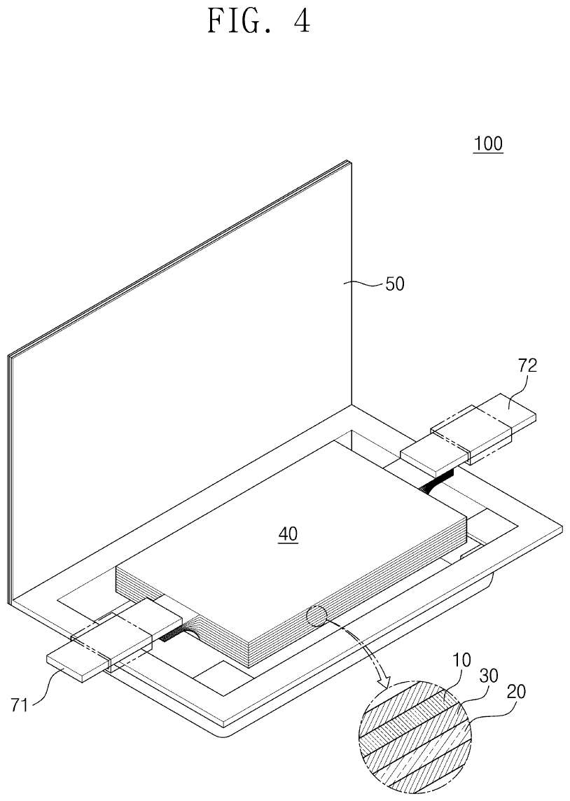

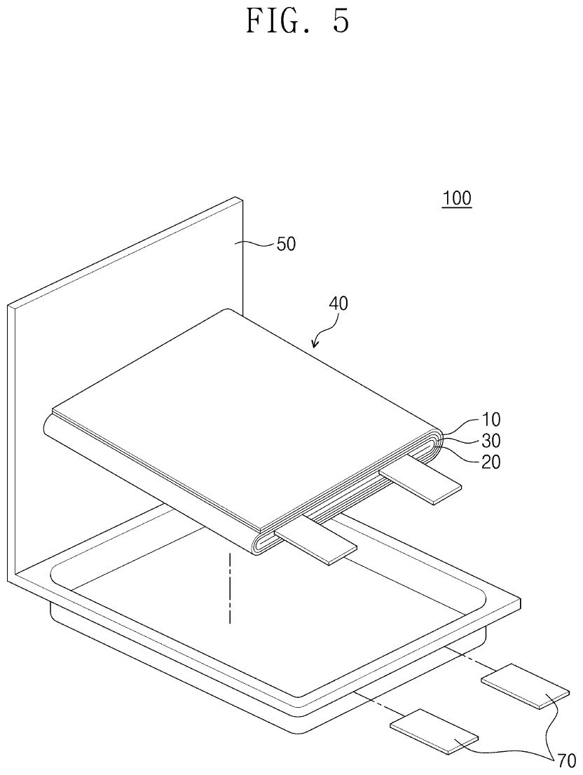

Based on a shape of a rechargeable lithium battery, the rechargeable lithium battery may be classified into cylindrical, prismatic, pouch, and/or coin types (or kinds). FIGS. 2-5 illustrate simplified diagrams showing rechargeable lithium batteries according to embodiments, with FIG. 2 showing a cylindrical battery, FIG. 3 showing a prismatic battery, and FIGS. 4-5 showing pouch-type batteries. Referring to FIGS. 2-4, a rechargeable lithium battery 100 may include an electrode assembly 40 in which a separator 30 is between a positive electrode 10 and a negative electrode 20, and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4-5, the rechargeable lithium battery 100 may include an electrode tab 70 (FIG. 5), for example, a positive electrode tab 71 and a negative electrode tab 72 (FIG. 4), which electrode tab 70 serves as an electrical path that externally induces a current generated in the electrode assembly 40.

The rechargeable lithium battery may have a maximum charge voltage of equal to or greater than about 4.45 V. For example, the maximum charge voltage may range from about 4.45 V to about 4.55 V.

The rechargeable lithium battery according to an embodiment of the present disclosure may be applied to automotive vehicles, mobile phones, and/or any other suitable electrical devices, but the present disclosure is not limited thereto.

The following will describe embodiments and comparative examples of the present disclosure. The following embodiments, however, are merely examples, and the present disclosure is not limited to embodiments discussed below.

### EMBODIMENT AND COMPARATIVE

An electrolyte and a rechargeable lithium battery were fabricated by the

following method.

### Embodiment 1

### 1. Preparation of Electrolyte

0.9 M LiPF₆ and 0.25 M LiFSI were dissolved in a non-aqueous organic solvent including ethylene carbonate (EC), ethylmethyl carbonate (EMC), and dimethyl carbonate (DMC) mixed in a volume ratio of 25:55:20, and an additive represented by Chemical Formula 1 below was added in an amount of 0.5 wt % relative to the total 100 wt % of an electrolyte to prepare the electrolyte.

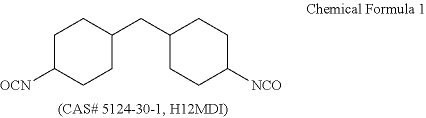

### 2. Fabrication of Rechargeable Lithium Battery

LiNi_{0.91}Co_{0.07}Al_{0.02}O₂ as a positive electrode active material, polyvinylidene fluoride as a binder, and Ketjen black as a conductive material were mixed in a weight ratio of 97:2:1, and the mixture was dispersed in N-methyl pyrrolidone to prepare a positive electrode active material slurry.

The positive electrode active material slurry was coated on an A1 foil of 14 μm in thickness, dried at 110° C., and then pressed to manufacture a positive electrode.

Artificial graphite and a silicon-carbon composite mixed in a weight ratio of 93:7 as a negative electrode active material, styrene-butadiene rubber as a binder, and carboxymethyl cellulose as a thickener were mixed in a weight ratio of 97:1:2, and the mixture was dispersed in distilled water to prepare a negative electrode active material slurry.

The silicon-carbon composite included a core including artificial graphite and silicon particles, and a coal-based pitch coated on a surface of the core.

The negative electrode active material slurry was coated on a Cu foil of 10 μm in thickness, dried at 100° C., and then pressed to manufacture a negative electrode.

The positive electrode, the negative electrode, and a polyethylene separator of 25 μm in thickness were assembled to manufacture an electrode assembly, and the electrolyte was introduced to fabricate a rechargeable lithium battery.

### Embodiment 2

A rechargeable lithium battery was fabricated according to substantially the same method as in Embodiment 1, except that the additive was prepared by adding in an amount of 0.1 wt % relative to the total 100 wt % of the electrolyte.

### Embodiment 3

A rechargeable lithium battery was fabricated according to substantially the same method as in Embodiment 1, except that the additive was prepared by adding in an amount of 1 wt % relative to the total 100 wt % of the electrolyte.

### Embodiment 4

A rechargeable lithium battery was fabricated according to substantially the same method as in Embodiment 1, except that 1.0 M LiPF₆ and 0.15 M LiFSI were dissolved in the non-aqueous organic solvent.

### Embodiment 5

A rechargeable lithium battery was fabricated according to substantially the same method as in Embodiment 1, except that 0.575 M LiPF₆ and 0.575 M LiFSI were dissolved in the non-aqueous organic solvent.

### Embodiment 6

A rechargeable lithium battery was fabricated according to substantially the same method as in Embodiment 1, except that 0.15 M LiPF₆ and 1.0 M LiFSI were dissolved in the non-aqueous organic solvent.

### Comparative 1

A rechargeable lithium battery was fabricated according to substantially the same method as in Embodiment 1, except that no additive was mixed, no LiFSI was dissolved, and 1.15 M LiPF₆ was dissolved in the non-aqueous organic solvent.

Table 1 below shows additive compositions of electrolytes for the rechargeable lithium batteries according to Embodiments and Comparative.

TABLE 1

| | |
|---|---|
| Additive (wt %*) | Lithium salt (M) |

| | H12MDI | LiPF₆ | LiFSI |
|---|---|---|---|
| Embodiment 1 | 0.5 | 0.9 | 0.25 |
| Embodiment 2 | 0.1 | 0.9 | 0.25 |
| Embodiment 3 | 1.0 | 0.9 | 0.25 |
| Embodiment 4 | 0.5 | 1.0 | 0.15 |
| Embodiment 5 | 0.5 | 0.575 | 0.575 |
| Embodiment 6 | 0.5 | 0.15 | 1.0 |
| Comparative 1 | —** | 1.15 | —** |

*The value of wt % is based on the total 100 wt % of the electrolyte.
**The mark ‘—’ indicates no addition during the preparation of the electrolyte.

### EVALUATION EXAMPLE

### Evaluation 1: Storage Characteristics at High Temperature (60° C.) (Capacity Retention Rate and DCIR Increase Rate)

The rechargeable lithium batteries fabricated according to Embodiments 1 to 6 and Comparative 1 were charged and discharged once at 0.2 C to thereby measure charge and discharge capacities (initial capacity). The rechargeable lithium batteries fabricated according to Embodiments 1 to 6 and Comparative 1 were charged at a 0.2 C-rate to 4.25 V, and then rested at 60° C. for 30 days. The rechargeable lithium batteries were discharged at a 0.5 C-rate to 2.75 V, and then a discharge capacity (30 days discharge capacity) was measured after being rested at high temperatures. The measured initial capacity and discharge capacity were substituted into the following Equation 1 to calculate a high-temperature storage capacity retention rate. Table 1 shows the results of the foregoing evaluation.

$$High - temperature storage capacity retention rate ( \% ) = \{ 30 days discharge capacity / initial capacity \} \times 100 \qquad Equation 1$$

The rechargeable lithium batteries fabricated according to Embodiments 1 to 6 and Comparative 1 were allowed to measure their initial direct-current internal resistance (initial DCIR) as ΔV/ΔI (voltage change/current change). The rechargeable lithium batteries fabricated according to Embodiments 1 to 6 and Comparative 1 were allowed to measure their initial direct-current internal resistance as ΔV/ΔI (voltage change/current change) after being rested at a high temperature (60° C.) for 60 days (post-high-temperature-storage DCIR). A post-high-temperature-storage DCIR increase rate (%) was calculated according to the following Equation 2, and Table 2 shows the results of the foregoing evaluation.

$$Post - high - temperature - storage DCIR increase rate ( \% ) = ( DCIR after high - temperature storage / initial DCIR ) \times 100 \qquad Equation 2$$

TABLE 2

| | | | Post-high- | | | High- |
|---|---|---|---|---|---|---|
| | | Post-high- | temperature- | | | temperature |
| | | temperature | storage | | 30 days | storage |
| | Initial | storage | DCIR | Initial | discharge | capacity |
| | DCIR | DCIR | increase | capacity | capacity | retention |
| | (mΩ) | (mΩ) | rate (%) | (Ah) | (Ah) | rate (%) |
| Embodiment | 20.08 | 22.87 | 113.9 | 4.94 | 4.64 | 93.9 |
| 1 | | | | | | |
| Embodiment | 19.92 | 24.20 | 121.5 | 4.94 | 4.63 | 93.7 |
| 2 | | | | | | |
| Embodiment | 22.14 | 26.76 | 120.9 | 4.94 | 4.63 | 93.7 |
| 3 | | | | | | |
| Embodiment | 20.11 | 22.94 | 114.1 | 4.94 | 4.63 | 93.7 |
| 4 | | | | | | |
| Embodiment | 18.72 | 26.38 | 140.9 | 4.92 | 4.57 | 92.9 |
| 5 | | | | | | |
| Embodiment | 18.70 | 30.47 | 162.9 | 4.91 | 4.46 | 90.8 |
| 6 | | | | | | |
| Comparative | 18.74 | 35.73 | 190.7 | 4.70 | 4.29 | 91.2 |
| 1 | | | | | | |

### Evaluation 2: Gas Generation (60° C., 7 days)

The rechargeable lithium batteries fabricated according to Embodiments 1 to 6 and Comparative 1 were charged at 0.1 C to a voltage of 4.3 V (vs. Li) under the condition of constant current at 25° C., and then 0.05 C cut-off charged under the condition of constant voltage while maintaining 4.3 V. Thereafter, the rechargeable lithium batteries were each disassembled to place a positive electrode plate into a pouch filled with an electrolyte, and then stored for 7 days in an oven at 60° C. An Archimedes method was employed to convert a mass change of the pouch into a volume change, and Table 3 shows the result.

The Archimedes' method is a way of measuring an amount of gas generation by periodically measuring a weight of the pouch in a tank filled with water and converting a weight change into a volume change.

TABLE 3

| | | Amount of gas | |
|---|---|---|---|
| | Initial amount of | generation after high- | Gas |
| | gas generation | temperature storage | increase |
| | (mL) | (at 60° C., 7 days, mL) | rate (%) |
| Embodiment 1 | 10.18 | 10.42 | 102.4 |
| Embodiment 2 | 10.21 | 10.94 | 107.1 |
| Embodiment 3 | 10.17 | 10.46 | 102.9 |
| Embodiment 4 | 10.19 | 10.45 | 102.6 |
| Embodiment 5 | 10.22 | 11.41 | 111.6 |
| Embodiment 6 | 10.21 | 11.62 | 113.8 |
| Comparative 1 | 10.23 | 11.57 | 113.1 |

### Evaluation 3: Room-Temperature Cycle Characteristics (Capacity Retention Rate)

The rechargeable lithium batteries fabricated according to Embodiments 1 to 6 and Comparative 1 were allowed to evaluate their room-temperature cycle characteristics under the following conditions.

The rechargeable lithium batteries were charged and discharged at 25° C. for 200 cycles under the condition of 0.33 C charge (CC/CV, 4.45 V, 0.025° C. cut-off) and 1.0 C discharge (CC, 2.5 V cut-off) to thereby measure changes in discharge capacity and direct-current internal resistance. A ratio of the discharge capacity after 200 cycles to an initial discharge capacity was calculated, and Table 4 shows the results of the foregoing evaluation.

TABLE 4

| | Capacity retention rate |
|---|---|
| | (at 25° C., 200 cycles, %) |
| Embodiment 1 | 98.1 |
| Embodiment 2 | 97.4 |
| Embodiment 3 | 97.5 |
| Embodiment 4 | 97.9 |
| Embodiment 5 | 95.2 |
| Embodiment 6 | 94.3 |
| Comparative 1 | 94.9 |

An electrolyte for a rechargeable lithium battery according to an embodiment may be applied to achieve the rechargeable lithium battery whose resistance increase is suppressed or reduced at high-temperature storage and whose stability and cycle-life characteristics are excellent.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

While the subject matter of this disclosure has been described in connection with what is presently considered to be example embodiments, it is to be understood that the present disclosure is not limited to the disclosed embodiments and is intended to cover various modifications and equivalent arrangements included within the spirit and scope of the appended claims and equivalents thereof, and therefore the aforementioned embodiments should be understood to be examples but not limiting this disclosure in any way.

What is claimed is:

1. An electrolyte for a rechargeable lithium battery, the electrolyte comprising:
a non-aqueous organic solvent;
a phosphorus-based lithium salt;
an imide-based lithium salt; and
an additive,
wherein the additive comprises an aliphatic diisocyanate compound.

2. The electrolyte as claimed in claim 1, wherein the aliphatic diisocyanate compound comprises a C3 to C20 alicyclic diisocyanate compound.

3. The electrolyte as claimed in claim 1, wherein the aliphatic diisocyanate compound comprises 1,6-hexamethylene diisocyanate (HDI), 4,4′-diisocyanate dicyclohexylmethane (H12MDI), 5-isocyanate-1-isocyanatomethyl-1,3,3-trimethylcyclohexane (isophorone diisocyanate, IPDI), or a combination thereof.

4. The electrolyte as claimed in claim 1, wherein the additive is comprised in an amount of about 0.01 to 5 parts by weight relative to a total 100 parts by weight of the electrolyte for the rechargeable lithium battery.

5. The electrolyte as claimed in claim 1, wherein the phosphorus-based lithium salt comprises lithium hexafluorophosphate (LiPF₆), lithium difluorophosphate (LiPO₂F₂), lithium tetrafluorophosphate oxalate (LiPF₄(C₂O₄), lithium pentafluorophosphate oxalate (LiPF₅(O₂C₂)), lithium pentafluorophosphate isocyanate (LiPF₅(OCN)), or a combination thereof.

6. The electrolyte as claimed in claim 1, wherein the phosphorus-based lithium salt is lithium hexafluorophosphate (LiPF₆).

7. The electrolyte as claimed in claim 1, wherein the imide-based lithium salt is a bis(sulfonyl)imide-based lithium salt.

8. The electrolyte as claimed in claim 1, wherein the imide-based lithium comprises Li(FSO₂)₂N (lithium bis (fluorosulfonyl) imide, LiFSI), LiN(CₓF₂ₓ₊₁SO₂)(C_{y}F_{2y+1}SO₂), wherein x and y are each independently an integer of 1 to 20, or a combination thereof.

9. The electrolyte as claimed in claim 8, wherein the imide-based lithium salt is Li(FSO₂)₂N (lithium bis(fluorosulfonyl)imide, LiFSI).

10. The electrolyte as claimed in claim 1, wherein the phosphorus-based lithium salt and the imide-based lithium salt are comprised in a molar ratio of about 1:0.1 to about 1:5.

11. The electrolyte as claimed in claim 1, wherein the phosphorus-based lithium salt and the imide-based lithium salt are comprised in a molar ratio of about 1:0.25 to about 1:1.

12. The electrolyte as claimed in claim 1, wherein an amount of the phosphorus-based lithium salt is in a range of about 0.3 M to about 1.5 M.

13. The electrolyte as claimed in claim 1, wherein an amount of the imide-based lithium salt is in a range of about 0.2 M to about 1.0 M.

14. The electrolyte as claimed in claim 1, wherein the non-aqueous organic solvent consists of a carbonate-based solvent.

15. The electrolyte as claimed in claim 1, wherein the non-aqueous organic solvent comprises ethylene carbonate (EC), dimethyl carbonate (DMC), diethyl carbonate (DEC), dipropyl carbonate (DPC), methylpropyl carbonate (MPC), ethylpropyl carbonate (EPC), ethylmethyl carbonate (EMC), or a combination thereof.

16. The electrolyte as claimed in claim 1, wherein the non-aqueous organic solvent comprises ethylene carbonate (EC), dimethyl carbonate (DMC), and ethylmethyl carbonate (EMC).

17. A rechargeable lithium battery, comprising:
a positive electrode comprising a positive electrode active material;
a negative electrode comprising a negative electrode active material; and
the electrolyte for the rechargeable lithium battery as claimed in claim 1.

18. The rechargeable lithium battery as claimed in claim 17, wherein the positive electrode active material comprises lithium nickel-based oxide, lithium cobalt-based oxide, lithium manganese-based oxide, lithium iron phosphate-based compounds, cobalt-free nickel-manganese-based oxide, or a combination thereof.

19. The rechargeable lithium battery as claimed in claim 17, wherein the negative electrode active material comprises a carbon-based negative electrode active material, a Si-based negative electrode active material, or a combination thereof.

20. The rechargeable lithium battery as claimed in claim 17, wherein a maximum charge voltage of the rechargeable lithium battery is equal to or greater than about 4.45 V.
